(19) United States
(12) Patent Application Publication
(10) Pub. No.: US 2016/0185191 A1
(43) Pub. Date: Jun. 30, 2016

(54) AUTOMATIC VEHICLE SUN SHADE

(71) Applicant: ZIRVE UNIVERSITESI, Gaziantep (TR)

(72) Inventor: Hüseyin Emre KANKAYA, Gaziantep (TR)

(73) Assignee: ZIRVE UNIVERSITESI, Gaziantep (TR)

(21) Appl. No.: 14/851,335

(22) Filed: Sep. 11, 2015

(30) Foreign Application Priority Data
Dec. 31, 2014 (TR) 2014/16406

(51) Int. Cl. B60J 3/02; G05D 3/12; H02J 7/00; B60Q 1/26

(52) U.S. Cl. CPC B60J 3/026; B60Q 1/26; G05D 3/12; H02J 7/0045; H02J 7/0054

(57) ABSTRACT

An automatic shading device has the ability to move in two axes, providing shade to the user's eye at all times depending on the angles of incidence of varying sunbeams on the vehicle windscreen, and the eye level of the user. The shading device functions when the vehicle is in motion without requiring the user's intervention.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to a vehicle sun shade comprising a two robot arm on the end of which a darkened transparent material is fixed for preventing sunlight from directly entering the driver's eye while vehicles are travelling.

In particular, the invention relates to a vehicle sun shade which can automatically move according to calculations made with the angle at which the sun hits the vehicle windscreen and the driver's eye level.

2. Description of Related Art Including Information Disclosed Under 37 CFR 1.97 and 37 CFR 1.98.

Today, vehicle sun shades are comprised of a mechanical system fixed onto a vehicle windscreen, capable of moving double-jointedly by the driver and made of a non-transparent material. Sun shades having the same sun shade mechanics and made of a coloured transparent material are also present.

In some large vehicles, such as buses, there are curtain systems which are motor controlled and may be wound down and removed with the driver pressing buttons. In today's sun shades, the sun shades cannot change position without the driver's intervention as the angles of the sun change when the vehicle is in motion. As the intervention of the driver may distract him/her, this increases the danger of accidents. Additionally, these systems do not pose an obstacle for certain positions of the sun. In order to prevent this, many drivers use sunglasses while driving in the daytime, yet this hinders vision when entering dark environments such as tunnels.

The summary of Application No. DE202010009658 resulting from technical research relates to automatic visors for vehicles.

Being another application resulting from technical research U.S. Pat. No. 5,478,131A relates to a car sun visor with an adjustable panel. However, in addition to all of these, present structures possess a novelty aiming at providing a solution to the above mentioned disadvantages.

In conclusion, due to the disadvantages mentioned above and the insufficiency of the present solutions regarding the subject, a need for making a development in the related field of the art was rendered necessary.

### BRIEF SUMMARY OF THE INVENTION

The invention has been constituted by being influenced from the present cases and aims to resolve the above mentioned disadvantages.

The primary object of the invention is to prevent the sun from entering the driver's eyes while driving by moving a darkened transparent material in two axes.

The object of the invention is to provide a device which automatically performs this process via servo motors by calculating the position at which the sunlight preventing material needs to be located without requiring the intervention of the driver. Thus, the driver does not need to adjust the sun shade as in other systems while driving.

Another object of the invention is to provide a device which protects the driver's eyes from sunbeams without hindering his/her vision, even if the position of the sun falls below the driver's head level as the sun shade itself and the connecting arms are transparent, and due to its ability to move biaxially.

A further object of the invention is to reduce the risk of traffic accidents by preventing distraction caused by manual adjustments while driving, with its feature of being able to be automatically adjusted. The structural and characteristic properties and all of the advantages of the invention will become clearer with the written detailed description by means of the following figures and the references to these figures and therefore the evaluation needs to be made taking these figures and detailed description into account.

### BRIEF DESCRIPTION OF THE SEVERAL VIEWS OF THE DRAWINGS

FIG. 1 is a drawing illustrating the automatic shading device of the invention.

FIG. 2 is a drawing representatively illustrating the connections of the automatic shading device of the invention.

FIG. 3 illustrates the angle relationship between the sun shade of the automatic shading device of the invention and the driver.

The drawings do not necessarily have to be scaled and the details, which are not necessary in order to understand the present invention may have been excluded. Furthermore, at least substantially equal elements or elements with at least substantially equal functions are shown with the same numbers.

### DESCRIPTION OF THE PART REFERENCES

1. Vehicle Windscreen
2. Automatic Shading Device
3. Fastening Apparatus
4. Light Sensor Sequence
5. Power Unit
6. Charge Port
7. Calibration Button
8. Energy and Signal Transmission Cable
9. Servo Motor-1
10. Angle Measurement Sensor-1
11. Servo Motor-2
12. Angle Measurement Sensor-2
13. Sun Shade
14. Connecting Arms
15. Joint
20. Interface Circuits
21. Microcontroller
22. Motor Drive
26. Calibration Indicator
xₛ: distance in the x axis between the user location and the fixed focal point
yₛ: distance in the y axis between the user location and the fixed focal point
zₛ: distance in the z axis between the user location and the fixed focal point
y₂: distance in the y axis between the centre of the sun shade and the fixed focal point
z₂: distance in the z axis between the centre of the sun shade and the fixed focal point
L₁: connecting arm length
L₂: connecting arm length
θ: connecting arm angle
z₁: distance in the z axis between the user location and the centre of the sun shade
y₁: distance in the y axis between the user location and the centre of the sun shade
α: angle which the sunbeams form with the x-y plane
β: angle which the sunbeams form with the x-z plane

### DETAILED DESCRIPTION OF THE INVENTION

In this detailed description, the preferred embodiments of the invention are disclosed only for the better understanding of the subject and should not be considered as limiting to the scope of the invention.

The components and functions thereof constituting the automatic shading device (2) providing shade to the user's eye at all times depending on the angles of incidence of varying sunbeams on the vehicle windscreen (1), and the eye level of the user/driver, even when the vehicle is in motion are as follows:
A vehicle windscreen (1) forms a surface for fixing an automatic shading device (2) with a fastening apparatus (3).
A fastening apparatus (3) enables the automatic shading device (2) to be fixed to the vehicle windscreen (1).
A light sensor sequence (4) is used for determining the angle at which sunbeams hit the vehicle windscreen (1).
A power unit (5) enables the batteries of the automatic shading device (2) to be charged and the energy to be transmitted to the circuit elements.
A charge port (6) enables the automatic shading device (2) to be charged with the energy obtained from the vehicle's battery.
A calibration button (7) begins calibration on the position of connecting arms (14) adjusted by the user so as to shade the user's eyes, during first use. The connecting arms (14) are adjusted so as to shade the user's eyes and the calibration button (7) is pressed by the user. Then, the eye level is calculated by the microcontroller (21) using the angle of incidence of the sunbeams and the angle of the joints (15), and later joint (15) movements are performed according to this calculation.
An energy and signal transmission cable (8) provides power and signal transmission from the microcontroller (21) and the power unit (5) to the servo motor-2 (11). Furthermore, this receives data from the angle measurement sensor-2 (12).
A servo motor-1 (9) moves the connecting arm (14) connected to the part fixed to the vehicle windscreen (1).
An angle measurement sensor-1 (10) is used for calculating the angle of the connecting arm (14) connected to the part fixed to the vehicle windscreen (1).
A servo motor-2 (11) moves the connecting arm (14) connected to the sun shade (13).
An angle measurement sensor-2 (12) is used for calculating the angle of the connecting arm (14) connected to the sun shade (13).
A sun shade (13) enables shade to form at the eye level of the driver. This is of transparent material. Also, the visual field is not affected as this is transparent.
Connecting arms (14) provide the connections between the sun shade (13), joints (15) and part fixed onto the vehicle windscreen (1). Also, the visual field is not affected as this is transparent.
Joints (15) enable the connecting arms (14) to rotate freely.
Interface circuits (20) transform the changes in the calibration button (7), light sensor sequence (4) and angle measurement sensor-1 and 2 (10, 12) into electrical forms which the microcontroller (21) can perceive.
A microcontroller (21) calculates the position where the connecting arms (14) should be located according to the data received from the light sensor sequence (4) and angle measurement sensor-1 and 2 (10, 12) for the user's eye level to be shaded. Additionally, the microcontroller (21) enables the servo motors-1 and 2 (9, 11) to bring the connecting arms (14) to an appropriate position by moving the joints (15). Finally, this component makes calculations according to the signals received from the light sensor sequence (4) for the sun shade (13) to be calibrated according to the driver's height, sitting position and seat location.
A motor drive (22) provides the current values required for the servo motors-1 and 2 (9, 11) to operate according to the signals received form the microcontroller (21).
A calibration indicator (26) lights up to notify the calibration has been done when the user location is calculated.

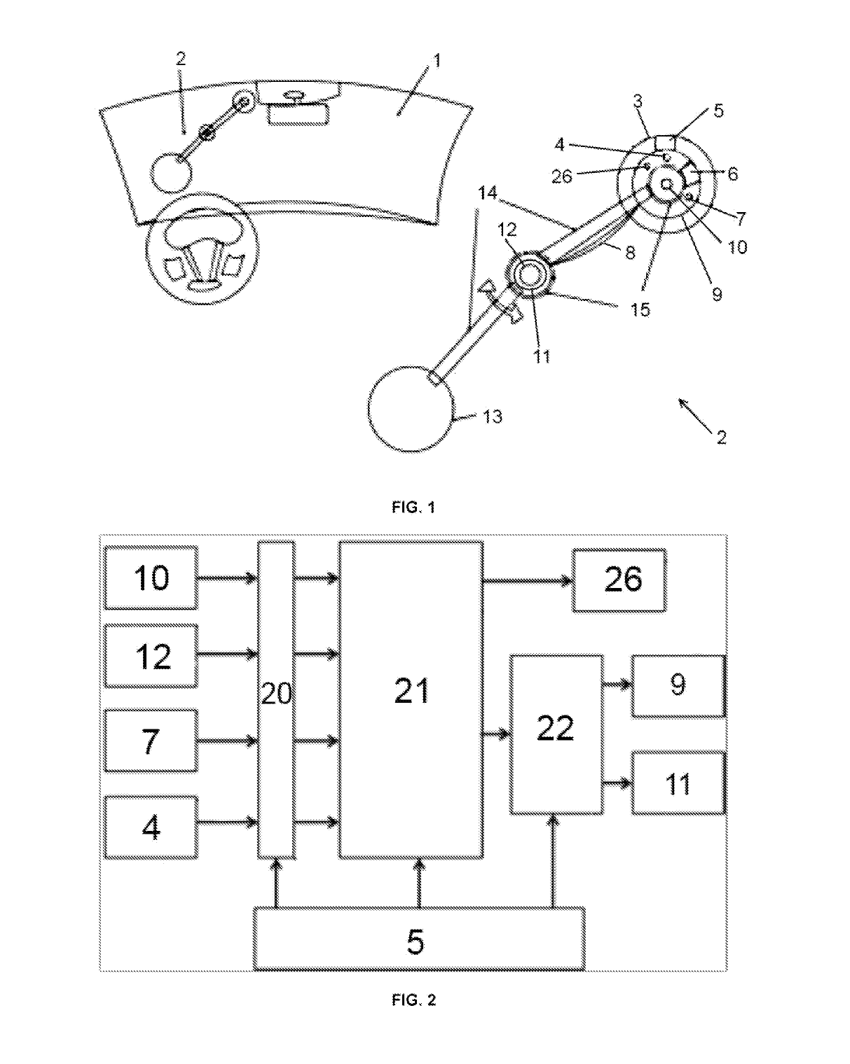

The invention is an electronically controlled mechanical device which can be fastened to a vehicle windscreen (1) as in FIG. 1. The fixing process is enabled with a fastening apparatus (3). There is a sun shade (13) obtained from a darkened transparent material on the farthermost part of the automatic shading device (2). This material enables the eye level of the driver/user to be shaded without hindering his/her vision.

Both the sun's location and the angle at which sunbeams hit the vehicle windscreen (1) due to the vehicle's movements change continuously throughout the day while a vehicle is in motion. The sun shade (13) produced from darkened transparent material for preventing beams hitting the eye level of the driver through the vehicle windscreen (1) needs to be movable against these changes. This movement is performed in two axes with the connecting arms (14) which are components of the device. The servo motors-1 and 2 (9, 11) are placed into the joints (15) of the system to automatically enable movements without the driver's intervention. The correct calculation of the sun shade's (13) location and moving the servo motors-1 and 2 (9, 11) accordingly is enabled with the microcontroller (21). As the output currents of the microcontroller (21) are not sufficient for driving the motor, this current is provided with the motor drives (22). A feedback mechanism is present in the device for mistakes not to be made in the sun shade (13) location. The microcontroller (21) receives the angle of repose information of the connecting arms (14) from the angle measurement sensors-1 and 2 (10, 12), and compares these with the values which they are meant to be. If there is a difference, the microcontroller (21) transmits a signal to the servo motors-1 and 2 (9, 11) again for they can be brought to the correct location.

Two values are necessary for the correct location of the sun shade (13). There first thereof is the angle of the sun and the vehicle windscreen (1). This value is obtained from the light sensor sequence (4) placed on the automatic shading device (2). This sensor system, and method of calculating the sunbeams' the angle of incidence is the same as the system used in photovoltaic solar panels following the sun. The data obtained from the light sensor sequence (4) are converted into a form which the microcontroller (21) will process with the interface circuit (20). The microcontroller (21) calculates the sunbeams' angle of incidence by interpreting the values received from the interface circuit (20).

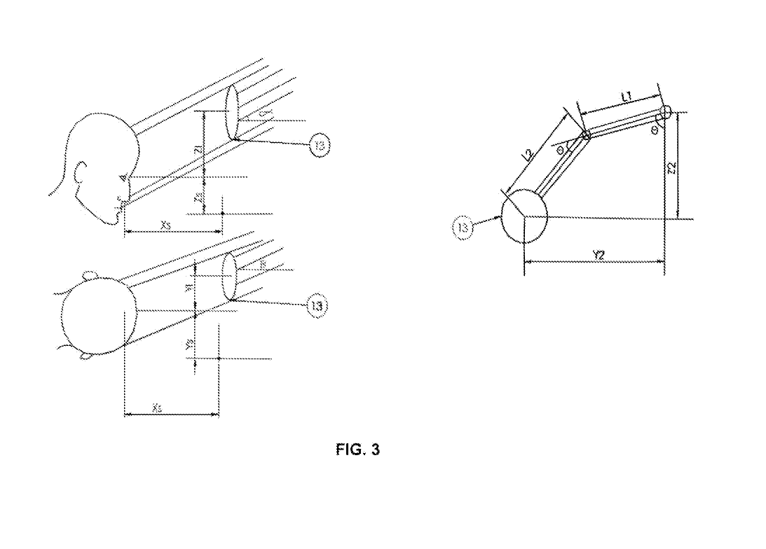

The second value required for the correct location of the sun shade (13) is the location of the driver's eye level. If the eye level is known, the microcontroller (21) may calculate the angles which the connecting arms (14) need to perform. FIG. 3 illustrates the sun shade (13) and user.

We can define the following (see, FIG. 3):
the mid-point of the user's eyes as the user location,
the centre of the servo motor-1 (9) as the fixed focal point,
the central point of the sun shade (13) as the sun shade (13) centre,
the distance in the x axis between the user location and the fixed focal point as xₛ,
the distance in the y axis between the user location and the fixed focal point as yₛ,
the distance in the z axis between the user location and the fixed focal point as zₛ,
the distance in the z axis between the user location and the sun shade (13) centre as z₁,
the distance in the y axis between the user location and the sun shade (13) centre as y₁,
the angle which the sunbeams form with the x-y plane as α,
the angle which the sunbeams form with the x-z plane as β.

Herefrom we may obtain the following equations:

z₁=xₛ tan(α)

y₁=xₛ tan(β)

Assuming that the user location is known, the z₁ and y₁ values may be found as the α and β values are obtained from the data received from the light sensor sequence (4). In this case, the distances in they and z axes between the sun shade (13) centre and the fixed focal point may be found as follows (see, FIG. 3):

y₂=yₛ+xₛ tan(β)

z₂=zₛ+xₛ tan(α)

The angles which the connecting arms (14) need to perform may be found from the following formulas:

$${θ}_{2} = arccos ( \frac{{z}_{2}^{2} + {y}_{2}^{2} - {L}_{1}^{2} - {L}_{2}^{2}}{2 {L}_{1} {L}_{2}} )$$

$${θ}_{1} = arcsin ( \frac{{L}_{2} sin ( {θ}_{2} )}{\sqrt{{z}_{2}^{2} + {y}_{2}^{2}}} ) + arctan ( \frac{{z}_{2}}{{y}_{2}} )$$

If the user location is not known, the level and distance information may be calculated while the vehicle is not in motion with the driver adjusting the connecting arms (14) while the sunbeams are at two different angles so that the sun does not enter his/her eyes and pressing the calibration button (7). Because, angle values of the connecting arms (14) are obtained from the angle measurement sensors-1 and 2 (10, 12) and the sunlight angle of incidence are obtained, at that moment. Using these values, the microcontroller (21) obtains a correct equation for the driver's eye level location. The intersection of two correct equations obtained as a result of the calibration performed in two different angles gives the location of the driver. If there isn't an intersection point of these two lines due to calculation and measurement errors, the points where the two lines are closest together are calculated as the central driver location. When the calculation has finished, the calibration indicator (26) transmits an alert regarding the driver location being calculated. After this adjustment has been made, the sun shade (13) is dynamically moved and is automatically adjusted by the device so that no sunlight enters the driver's eye level without an additional driver intervention.

As the automatic shading device (2) may be applied to the vehicle windscreen, it may also be enabled to be used by passengers other than the driver by being applied for side windows. Furthermore, the ability to move may be increased by making the number of joints (15) of the device three or more. Said sun shade (13) may be of various geometries such as a circle or an ellipse.

1. An automatic shading device providing shade to the user's eye at all times depending on the angles of incidence of varying sunbeams on the vehicle windscreen, and the eye level of the user even when the vehicle is in motion without requiring the user's intervention, characterised in comprising:
a fastening apparatus enabling the automatic shading device to be fixed onto the vehicle windscreen,
a light sensor sequence used for determining the angle at which sunbeams hit the vehicle windscreen,
a power unit enabling the batteries of the automatic shading device to be charged and the energy to be transmitted to the circuit elements,
a sun shade enabling shade to form at the eye level of the driver,
at least two joints enabling the connecting arms to rotate freely,
at least two connecting arms providing connections between the sun shade, joints and part fixed onto the vehicle windscreen of the automatic shading device,
a first servo motor moving the connecting arm connected to the part fixed to the vehicle windscreen of the automatic shading device,
a first angle measurement sensor used for calculating the angle of the connecting arm connected to the part fixed to the vehicle windscreen of the automatic shading device,
a second servo motor moving the connecting arm connected to the sun shade,
a second angle measurement sensor used for calculating the angle of the connecting arm connected to the sun shade,
a calibration button beginning calibration on the position of connecting arms adjusted by the user so as to shade the user's eyes, during first use while the vehicle is not in motion,
a microcontroller
calculating the position where the connecting arms should be located according to the data received from the light sensor sequence, and the first and second angle measurement sensors for the user's eye level to be shaded,
enabling the first and second servo motors to bring the connecting arms to an appropriate position by moving the joints according to its calculated position data,
calculating the eye level and performing later joint movements with this calculated eye level by making calculations according to the signals received from the light sensor sequence, the angle of incidence of the sunbeams and the angle of the joints for the sun shade to be calibrated according to the driver's height, sitting position and seat location,
interface circuits transforming the changes in the calibration button, light sensor sequence and first and second angle measurement sensors into electrical forms which the microcontroller can perceive,
a motor drive providing the current values required for the first and second servo motors, to operate according to the signals received form the microcontroller,
an energy and signal transmission cable enabling power and signal transmission from the microcontroller and the power unit to the second servo motor, and enabling the microcontroller to receive data from the second angle measurement sensor.

2. An automatic shading device according to claim 1, characterised in comprising:
a microcontroller
receiving the angle of repose information of the connecting arms from the first and second angle measurement sensors, and comparing these with the angle values which the connecting arms are meant to be,
transmitting a signal to the first and second servo motors again so as to be brought to the correct location if there is a difference between the angle values which the connecting arms are meant to be with the received angle information.

3. An automatic shading device according to claim 1, characterised in comprising:
a charge port enabling the automatic shading device to be charged with the energy obtained from the vehicle's battery.

4. An automatic shading device according to claim 1, characterised in comprising:
a calibration indicator lighting up to notify the calibration has been done after the user eye level is calculated.

5. An automatic shading device according to claim 1, characterised in that said sun shade is a darkened transparent material which does not hinder the user's vision.

6. An automatic shading device according to claim 1, characterised in that said connecting arms are transparent so as not to hinder the user's vision.
